(19) United States
(12) Patent Application Publication
(10) Pub. No.: US 2013/0117572 A1
(43) Pub. Date: May 9, 2013

(54) Portable electronic device, system and method for authenticating a document associated with a geographical location

(71) Applicant: Debreceni Egyetem, Debrecen (HU)

(72) Inventors: Attila BÉRCZES, Debrecen (HU); Éva CSERNUSNÉ ÁDÁMKÓ, Debrecen (HU); János Folláth, Szolnok (HU); Attila PETHÕ, Debrecen (HU)

(73) Assignee: DEBRECENI EGYETEM, Debrecen (HU)

(21) Appl. No.: 13/673,085

(22) Filed: Nov. 9, 2012

Related U.S. Application Data
(60) Provisional application No. 61/557,438, filed on Nov. 9, 2011.

(51) Int. Cl. H04L 9/32

(52) U.S. Cl. CPC H04L 9/3247
USPC 713/178

(57) ABSTRACT

In a portable electronic device, a method of authenticating a document associated with a geographical location is disclosed. A document is provided in the form of digital data, and a hash value is generated from the digital data of said document. Raw GPS data are received from at least one GPS satellite, and then digitally signed by a first private key of the portable electronic device. From the raw GPS data, exact GPS coordinates are calculated. A request for an authentic location stamp is sent to a certification unit, the request containing at least the hash value of the document, the raw GPS data and the exact GPS coordinates, wherein said request is digitally signed by a private key of the portable electronic device. In response to said location stamp request, a nonce value from the certification unit is received, said nonce value being digitally signed by a private key of the certification unit. A certification request is then sent to the certification unit, said request containing at least the hash value of the document, the raw GPS data, the exact GPS coordinates and the nonce value, wherein the certification request is digitally signed with said private key of the portable electronic device. In response to said certification request, a certified location stamp containing said certification request and a piece of time information is received, said location stamp being digitally signed by a private key of the certification unit. The certified location stamp is verified by using the corresponding public key of the certification unit, and if it is determined that the certified location stamp is signed by the certification unit, the certified location stamp will be assigned to the document.

This application claims priority to provisional application No. 61/557,438, filed Nov. 9, 2011, which is incorporated by reference herein.

### BACKGROUND OF THE INVENTION

1. Technical Field

The present invention generally relates to GPS-based location determination. More particularly, the invention relates to a mobile device, a system and a method for authenticating a document associated with a geographical location by using certified GPS information, as well as a computer program product for carrying out the method.

2. Description of the Related Art

With an increasing number of devices available incorporating location tracking systems, based on GPS (Global Positioning System) receivers, there are similarly an increasing number of applications, especially in the delivery and distribution sectors, as well as in the electronic administration, that are being enhanced by the use of devices that are adapted to record and store the geographical locations of themselves over time. For example, these devices could be placed in vehicles, couriers, packages or carried by individual distributors or administrative stuff in authority proceedings. This information is then used to retroactively view the geographical routes taken or places inspected by these items. In some cases this data is extremely important, for instance to prove to a client that a particular action was done, or attempted, along with the date and time that this occurred. However, it could be argued that once the recorded data has been retrieved from the recording device and stored elsewhere—usually in a computer system—it might be open to tampering. It would not be very difficult to modify the data in the file so as to show that a delivery appeared to be made when, in fact, it was not. However, by creating a cryptographic digital signature of the data before it leaves the device, such that any subsequent tampering of the data would show up during a validation process, the authenticity of the data can be proven.

Document WO 2008/087435 discloses a method of authenticating geographical location and time data obtained from a remote GPS logging device. The method comprises the steps of generating a data array based upon GPS signals received by the remote logging device; storing the geographical location and time data in a data array; creating a message digest for the stored data array; encrypting the message digest with a unique private key stored within the logging device, the encrypted message digest representing a digital signature of the stored data array: transmitting the stored data array and digital signature to a host computer; decrypting the digital signature using a public key that complements the private key, and obtaining a decrypted message digest; and comparing the encrypted and decrypted message digests, such that if they are identical then the received data array containing geographical location and time data is verified as authentic.

### SUMMARY OF THE INVENTION

It an object of the invention to further enhance the reliability of the document authenticating solutions of the prior art.

In a first aspect, the above object is achieved by providing in a portable electronic device, a method of authenticating a document associated with a geographical location, comprising:
providing a document in the form of digital data.
generating a hash value from the digital data of said document.
receiving raw GPS data from at least three GPS satellites.
digitally signing said raw GPS data with a first private key of the mobile device.
calculating the exact GPS coordinates from the raw GPS data,
sending a request for an authentic location stamp to a certification unit, the request containing at least the hash value of the document, the raw GPS data and the exact GPS coordinates, wherein said request is digitally signed by a private key of the portable electronic device,
in response to said location stamp request, receiving a nonce value from the certification unit, said nonce value being digitally signed with a private key of the certification unit,
sending a certification request to the certification unit, said request containing at least the hash value of the document, the raw GPS data, the exact GPS coordinates and the nonce value, wherein the certification request is digitally signed with said private key of the portable electronic device,
in response to said certification request, receiving a certified location stamp containing said certification request and a piece of time information, said location stamp being digitally signed by a private key of the certification unit,
verifying the certified location stamp by using a corresponding public key of the certification unit, and
if it is determined that the certified location stamp is signed by the certification unit, assigning the certified location stamp to the document.

In a second aspect, the above object is achieved by providing a portable electronic device for authenticating a document associated with a geographical location, the device comprising:
a GPS receiver,
a communication interface to an external electronic certification unit.
a processing module for calculating a hash value from digital data of a document stored in the device,
an authentication module configured to
   receive raw GPS data from the GPS receiver and send them to the calculation module,
   receive exact GPS coordinates from the calculation module,
   send a request for a location stamp to said certification unit, the request containing the hash value, the raw GPS data and the exact GPS coordinates,
   receive a nonce value from the certification unit in response to said location stamp request,
   send a certification request to said certification unit, the request containing the hash value, the raw GPS data, the exact GPS coordinates and the nonce value,
   receive a certified location stamp containing the certification request and a piece of time information, in response to said certification request,
   verify the certified location stamp, and
   assign the certified location stamp to said document if the verification is successful, and
a calculation module configured to
   receive raw GPS data from the authentication module
   calculate exact GPS coordinates from said raw, GPS data, and
   send the exact GPS coordinates to the authentication module.

In a third aspect, the above object is achieved by providing a system for authenticating a document associated with a geographical location, the system comprising a plurality of GPS satellites, an electronic certification unit, and at least one portable electronic device according to the invention.

In a fourth aspect, the above object is achieved by providing a computer program product for authenticating a document associated with a geographical location, wherein the program product contains instructions which, when being executed on a portable electronic device, carry out the above method.

With the help of the location stamp service it becomes possible to authenticate the GPS coordinates generated by any portable electronic device. For example, in case an authority intends to prove the violence of a legal regulation by a person, the officer in charge makes an official report by using a portable electronic device, such as a mobile phone, at the particular place of commitment, he locates the area with a GPS receiver, which is built in the portable electronic device, signs the report digitally and asks for an authentic location stamp with his portable electronic device. After all these, it will be proved where and when the report was made since the place is authentically certified by GPS coordinates and a time stamp.

### BRIEF DESCRIPTION OF THE DRAWINGS

FIG. 1 is schematic block diagram illustrating the system according to the present invention.

FIG. 2 is a communication flow diagram depicting the system entities shown in FIG. 1 and the data exchanges therebetveen carried out to authenticate a document.

FIG. 3 is a flow diagram depicting the major steps of the method according to the present invention.

FIG. 4 is a schematic block diagram of the portable electronic device according to the present invention.

### DETAILED DESCRIPTION OF THE PREFERRED EMBODIMENTS

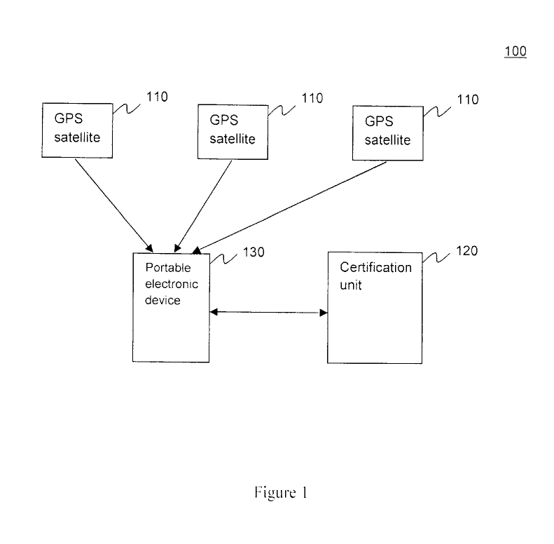

As shown in FIG. 1, a system 100 according to the present invention comprises a plurality of Global Positioning System (GPS) satellites 110, an electronic certification unit 120, and at least one portable electronic device 130 with a GPS receiver.

The GPS satellites 110 are used to provide raw GPS data from which the portable electronic device 130 calculates the exact coordinates of the actual spatial position of its location. In this context the term “GPS” is used to generally refer to any kind of space-based satellite navigation system, including the US-built GPS system and other similar systems that are either in use or under development, such as the Russian GLObal NAvigation Satellite System (GLONASS), the European Galileo positioning system (GNSS), the Chinese BeiDou and Compass navigation systems and the Indian Regional Navigational Satellite System (IRNSS).

The certification unit 120 is used to provide authenticate location stamps with time information for documents to be authenticated. The documents may include text data, image data, audio data, video data or any combination thereof.

The certification unit 120 is an entity, which is typically operated by an authority or a service provider, is independent from the measurement and can guarantee that nobody is capable of modifying the results obtained.

The portable electronic device 130, which incorporates a GPS receiver, may be any kind of portable electronic device that can communicate through a wireless connection with the electronic certification unit 120. The portable electronic device 130 may include a mobile phone, a smart phone, a laptop computer, a notebook, a netbook, a tablet PC, a PDA or the like. The wireless communication between the portable electronic device 130 and the electronic certification unit 120 may be carried out using any kind of wireless communications standard including, for example, GSM, EDGE, GPRS, LTE, WiFi, Bluetooth, etc.

The portable electronic device 130 comprises an authentication module, preferably implemented in the form of a software tool, this module being used to perform authentication of the raw GPS data that are received by the GPS receiver of the portable electronic device 130 from the GPS satellites 110, and to perform authentication of the exact GPS coordinates of the actual position calculated by the portable electronic device 130 itself from the raw GPS data by means of a calculation module, which is preferably also implemented in the form of a software tool.

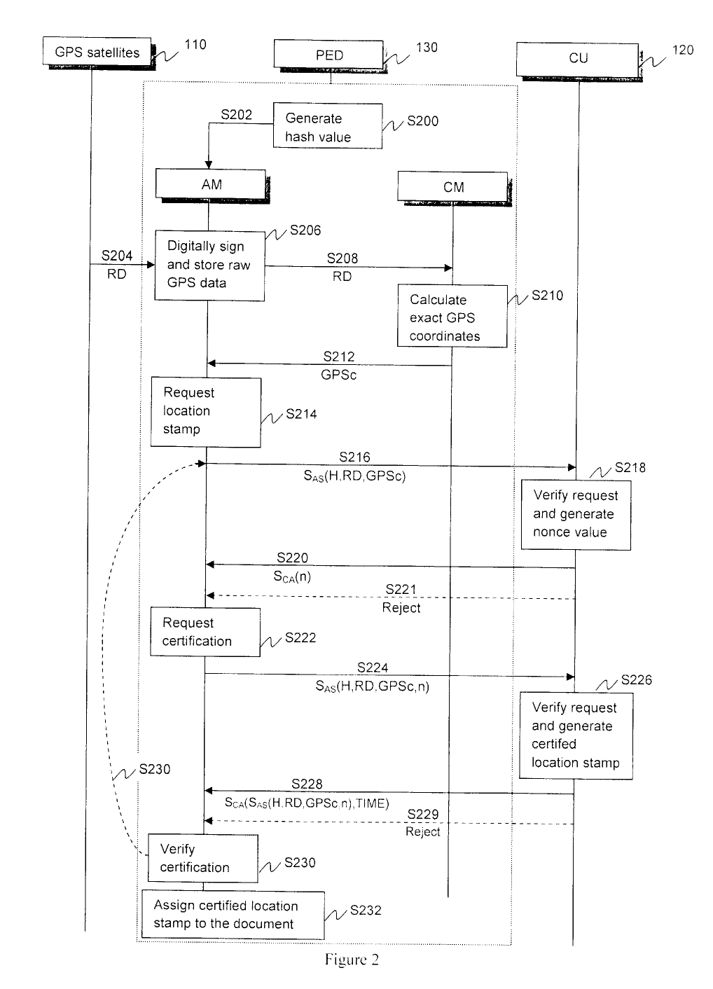

The communication flow between the authentication and calculation modules of the portable electronic device (PED) and between the portable electronic device and the GPS satellites and the external certification unit (CU) is illustrated in FIG. 2.

In the first step S200 of the communication process, an appropriate processing module of the portable electronic device 130 calculates a hash value, H, from the digital data. D. e.g. the plain text, of a document to be authenticated with a location stamp. Hashing results in a hash value H=h(D), wherein h is a hash function.

For example, a hash function as defined below may be used to generate a hash for the document at issue. Let q be a prime power and set

h(x₁, . . . ,xₙ)=a₁,x₁^{k}+ . . . +aₙxₙ^{k}+b₁x₁^{s}+ . . . +bₙxₙ^{s}∈ [symbol] _{q}[x₁, . . . ,xₙ]

such that 0<s<k<q and a₁, . . . aₙ, b₁, . . . bₙ≠0. This function is collision resistant. As to the implementation, for q a substantially large prime or a substantially large power of 2 is used. It is particularly preferred that q is larger than 2800.

In the above expression, x₁, . . . , xₙ, denote consecutive blocks of the document data to be hashed, the blocks having a length of [log q]. Here [log q] denotes the least integer larger than or equal to log q. The bits of the hash value h(x₁, . . . xₙ) will then constitute the hash code itself.

A detailed description of the feasibility, the safety and the robustness of the above defined hash function is described by A. Bérczes, J. Folláth and A. Petho. “On a family of preimage-resistant functions” (Tatra Mountains Mathematical Publication. No. 47, 2010, pp. 1-13), which paper is entirely incorporated herein by reference.

Next, said processing module of the portable electronic device 130 sends the hash value, H, of the document to the authentication module, AM, in step S202.

In step S204, the portable electronic device 130 obtains raw positioning data, RD, from at least three of the GPS satellites 110 by means of its built-in GPS receiver, and then in step S206, the authentication module, AM, produces a digital signature for the raw positioning data, RD, using its private key. S_{AS}, and the thus obtained digital signature, S_{AS}(RD), will be stored together with the raw positioning data, RD, in the portable electronic device 130 in order to prevent the raw GPS data from any unintentional modification or even from tempering.

After digitally signing the raw positioning data, the authentication module, AM, forwards the raw positioning data. RD, in the form as originally received from the GPS satellite(s) 110 to the calculation module, CM, of the portable electronic device 130 in step S208.

The calculation module, CM, calculates the global coordinates, GPSc, of the actual position of the portable electronic device 130 from the raw GPS positioning data, RD, in Step S210, and then returns the exact position coordinates, GPSc, to the authentication module, AM, in step S212. For the computation of an exact location position, the raw GPS data should be obtained at least from three GPS satellites 110.

In the following step S214, the authentication module, AM, concatenates the hash value, H, the raw positioning data, RD, and the calculated position coordinates, GPSc, and digitally signs them with its private key. S_{AS}, thereby generating a digital signature S_{AS}(H, RD, GPSc).

Next, the authentication module, AM, sends the plain data (H, RD, GPSc) and the digital signature S_{AS}(H, RD, GPSc) to the certification unit 120 in step S216. It is noted that in the flow diagram of FIG. 2, in some steps, for the sake of simplicity only the digital signature is shown as transmitted data. In these steps, however, the plain data, to which the given digital signature belongs, are also transmitted. The certification unit 120 makes a verification of the signature S_{AS}(H, RD, GPSc) in step S218 to determined whether the received signature was really generated by the authentication module, AS. The verification is performed by executing a verification function call using a corresponding public key V_{AS} of the authentication module, AM, for the signature S_{AS}(H, RD, GPSc), resulting in a verification value V_{AS}(S_{AS}(H, RD, GPSc)).

If the certification unit 120 determines that the received signature was generated by the authentication module, AM, it will generate a nonce value, n, by using a pseudorandom number generator in order to ensure the freshness of the protocol and to ensure that previous communications cannot be re-used in replay attacks.

Otherwise, if the certification unit 120 determines that the received signature was not generated by the authentication module, AM, it will reject to generate a location stamp in step S221, and the process terminates.

Next the certification unit 120 concatenates the received digital signature S_{AS}(H, RD, GPSc) and the nonce value, n, and digitally signs them with its private key, S_{CA}, thereby generating a digital signature S_{CA}(S_{AS}(H, RD, GPSc), n), which it sends together with the nonce value, n, to the portable electronic device 130 in step S220. The digital signature S_{CA}(S_{AS}(H, RD, GPSc), n) and n is received by the authentication module, AM, of the portable electronic device 130.

Upon receiving the digital signature S_{CA}(S_{AS}(H, RD, GPSc), n), the authentication module, AM, extracts the nonce value, n, from the digital signature in step S222, then it concatenates the hash value, H, the raw positioning data, RD, the calculated position coordinates, GPSc, and the nonce value, n, followed by digitally signing them with its private key, S_{AS}. Thereby a digital signature S_{AS}(H, RD, GPSc, n) is generated in step S222. This signature together with the plain data (H, RD, GPSc, n) is then sent by the authentication module, AM, to the certification unit 120 in step S224.

In the next step S226, the certification unit 120 makes a verification of the signature S_{AS}(H, RD, GPSc, n) to determined whether the received signature was really generated by the authentication module, AS. The verification is performed by executing the aforementioned verification function call using the public key V_{AS} for the signature S_{AS}(H, RD, GPSc, n), resulting in a verification value V_{AS}(S_{AS}(H, RID, GPSc, n)).

If the certification unit 120 determines that the recently received signature was generated by the authentication module, AM, it will record the time, TIME, of the successful verification, then concatenates the digital signature and the time value, and make an authentic location stamp S_{CA}(S_{AS}(H, RD, GPSc, n), TIME) by digitally signing said concatenated data with its private key, S_{CA}, thereby generating a digital signature, S_{CA}(S_{AS}(H, RD, GPSc, n), TIME). This signature is sent from the certification unit 120 to the authentication module, AM, in step S228, and is used as a certified location stamp assigned to the document.

If the certification unit 120 determines that the recently received signature was not generated by the authentication module, AM, in step S229 it will reject to generate a location stamp, and the process terminates.

Then in step S230, the authentication module, AM, makes a verification to determine whether the received digital signature S_{CA}(S_{AS}(H, RD, GPSc, n), TIME), i.e. the certified location stamp, is actually signed by the certification unit 120. This verification is performed by executing a verification function call using a public key V_{CA} of the certification unit 120 for the location stamp S_{CA}(S_{AS}(H, RD, GPSc, n), TIME), resulting in a verification value V_{CA}(S_{CA}(S_{AS}(H, RD, GPSc, n), TIME)).

If the authentication module, AM, determines that the recently received signature was generated by the certification unit 120, it will accept the certified location stamp as an authentic one in step S232, and the process will successfully terminated.

However, if authentication module, AM, determines that the recently received signature was not generated by the certification unit 120 in step S231 the process will return to step S216 and a new location stamp is requested by the authentication module, AM, from the certification unit 120.

It should be noted that for the digital signatures used for the above method, any appropriate standard, such as the Digital Signature Standard (DSS) (FIPS 186-3) may be used.

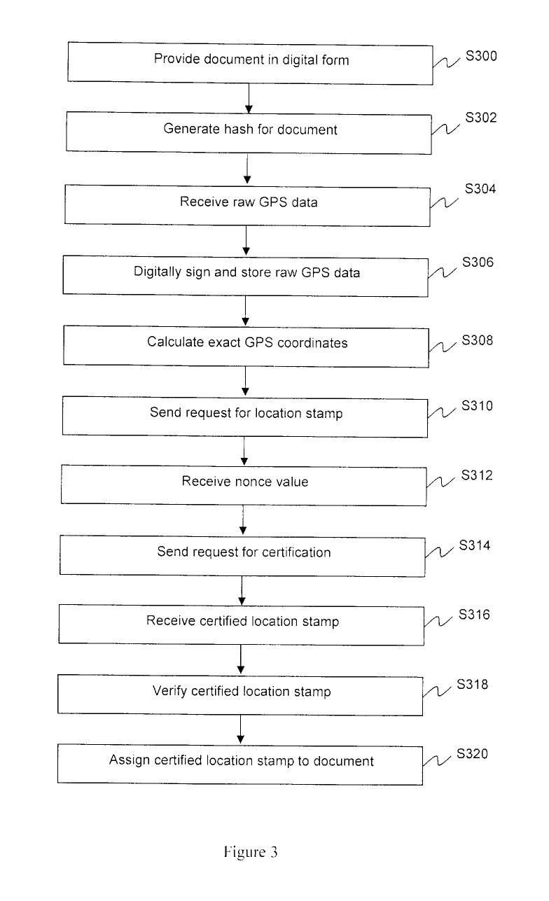

Now the method for authenticating a document associated with a geographical location will be described in accordance with the present invention. The method is performed in a portable electronic device comprising the above mentioned authentication module and calculation module arranged within said portable electronic device. The major steps of the method are depicted by the flow diagram shown in FIG. 3.

In a first step S300 of the method, a document to be authenticated by certified location information is provided in the portable electronic device in digital form. This document is preferably produced by the portable electronic device itself at the site, the location position of which is to be used to authenticate the document. It may also be appreciated that the document is produced externally to the portable electronic device and it is obtained by the portable electronic device from an external source, such as a central computer or central data base, or another portable electronic device, such as a photo camera, a video recorder, a digital voice recorder, a mobile phone or the like, wherein the use or the content of such document should be associated with the particular geographical location where the authenticating portable electronic device is operated.

In step S302, a hash value, H, is generated from the digital data of the electronic document. Next, in step S304, raw GPS data, RD, are received from at least one GPS satellite, preferably from a plurality of GPS satellites. The raw GPS data, RD, are then digitally signed with a first private key of the portable electronic device in step S306 in order to prevent the raw GPS data from any unintentional modification or even from tempering as mention above.

In step S308, the exact GPS coordinates are calculated from the raw GPS data, RD. Next, a request for an authentic location stamp is sent to an external electronic certification unit in step S310, the request containing at least the hash value, H, of the document, the raw GPS data, RD, and the exact GPS coordinates, GPSc, wherein said request is digitally signed by a private key, S_{AS}, of the portable electronic device.

In step S312, in response to said location stamp request, a nonce value, n, is received from the certification unit, said nonce value being digitally signed with a private key, S_{CA}, of the certification unit. Subsequently, a certification request is sent to the certification unit, said request containing at least the hash value, H, of the document, the raw GPS data, RD, the exact GPS coordinates, GPSc, and the nonce value, n, wherein the certification request is digitally signed with said private key, S_{AS}, of the portable electronic device in step S314.

In response to the certification request, the portable electronic device receives a certified location stamp in step S316, wherein the certified location stamp contains the certification request and a piece of time information, TIME, and is digitally signed by a private key, S_{CA}, of the certification unit.

Upon receiving the location stamp from the certification unit, the certified location stamp is verified in step S3018 by using a corresponding public key, V_{CA}, of the certification unit.

Finally, in step S320, the certified location stamp is assigned to the document if it is determined that the certified location stamp is actually signed by the certification unit.

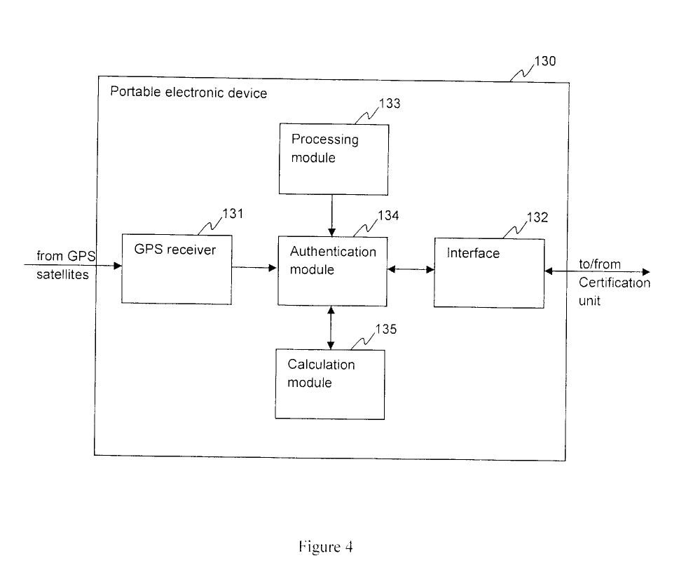

According to a third aspect of the invention, a portable electronic device for authenticating a document associated with a geographical location is also provided. A schematic block diagram of the portable electronic device is illustrated in FIG. 4.

The portable electronic device 130 comprises a GPS receiver 131, a communication interface 132 to an external electronic certification unit, a processing module 133, an authentication module 134 and a calculation module 135. It is obvious for a person skilled in the art that the portable electronic device may further comprise other processing modules, input/output units. etc. in a configuration dependent on the particular kind of the portable electronic device 130 (e.g. computer, mobile phone).

The communication interface 132 provides wireless communication between the portable electronic device 130 and the electronic certification unit according to a wireless communication protocol as mentioned above.

As the processing module 133 either the main processor of the portable electronic device 130, or an auxiliary processor or programmed logical circuit may be used.

The authentication module 134 is configured to perform at least the following operations:
receiving raw GPS data from the GPS receiver and sending them to the calculation module 135,
receiving exact GPS coordinates from the calculation module 135,
sending a request for a location stamp to said certification unit, the request containing a hash value, raw GPS data and exact GPS coordinates,
receiving a nonce value from the certification unit in response to said location stamp request,
sending a certification request to said certification unit, the request containing said hash value, said raw GPS data, said exact GPS coordinates and said nonce value,
receiving a certified location stamp containing the certification request and a piece of time information, in response to said certification request,
verifying the certified location stamp, and
assigning the certified location stamp to said document if the verification is successful.

The authentication module 134 is preferably implemented as a software built in a specific driver of the portable electronic device 130 so that all of the data used in the authentication module 134 be prevented from an attack of any software installed on the operation system of the portable electronic device 130.

The calculation module 135 is configured at least to calculate exact GPS coordinates from the raw GPS data received from the authentication module 134 and to send the exact GPS coordinates to the authentication module 134.

In a fourth aspect of the present invention, it is also provided a computer program product for authenticating a document associated with a geographical location. The program product contains instructions which, when being executed on a portable electronic device, carry out the above described method according to the invention.

While the portable electronic device, the system and the method according to the present invention have been described with reference to certain embodiments thereof, it will be understood by those skilled in the art that several modifications and alternatives thereof may be carried out without departing the scope of the invention defined by the appended claims.

What we claim is:

1. In a portable electronic device, a method of authenticating a document associated with a geographical location, comprising:
providing a document in the form of digital data,
generating a hash value from the digital data of said document,
receiving raw GPS data from at least three GPS satellites,
digitally signing said raw GPS data with a first private key of the portable electronic device,
calculating the exact GPS coordinates from the raw GPS data,
sending a request for an authentic location stamp to a certification unit, the request containing at least the hash value of the document, the raw GPS data and the exact GPS coordinates, wherein said request is digitally signed by a private key of the portable electronic device,
in response to said location stamp request, receiving a nonce value from the certification unit, said nonce value being digitally signed with a private key of the certification unit,
sending a certification request to the certification unit, said request containing at least the hash value of the document, the raw GPS data, the exact GPS coordinates and the nonce value, wherein the certification request is digitally signed with said private key of the portable electronic device,
in response to said certification request, receiving a certified location stamp containing said certification request and a piece of time information, said location stamp being digitally signed by a private key of the certification unit,
verifying the certified location stamp by using a corresponding public key of the certification unit, and
if it is determined that the certified location stamp is signed by the certification unit, assigning the certified location stamp to the document.

2. The method of claim 1, wherein the hash value of the document is calculated using the hash function
h(x₁, . . . ,xₙ)=a₁,x₁^{k}+ . . . +aₙxₙ^{k}+b₁x₁^{s}+ . . . +bₙxₙ^{s}∈ [symbol] _{q}[x₁, . . . ,xₙ]
wherein x₁, . . . , xₙ, are consecutive blocks of the digital data of the document to be hashed, said blocks having a length of [log q], wherein q is a substantially large prime or a substantially large power of 2, and 0<s<k<q and a₁, . . . aₙ, b₁, . . . . , bₙ≠0.

3. The method of claim 1, wherein the document includes any one of text data, image data, audio data and video data, or any combination thereof.

4. A portable electronic device for authenticating a document associated with a geographical location, the portable electronic device comprising:
a GPS receiver,
a communication interface to an external electronic certification unit,
a processing module for calculating a hash value from digital data of a document stored in the device,
an authentication module configured to
receive raw GPS data from the GPS receiver and send them to the calculation module,
receive exact GPS coordinates from the calculation module,
send a request for a location stamp to said certification unit, the request containing the hash value, the raw GPS data and the exact GPS coordinates,
receive a nonce value from the certification unit in response to said location stamp request,
send a certification request to said certification unit, the request containing the hash value, the raw GPS data, the exact GPS coordinates and the nonce value,
receive a certified location stamp containing the certification request and a piece of time information, in response to said certification request,
verify the certified location stamp, and
assign the certified location stamp to said document if the verification is successful, and
a calculation module configured to
receive raw GPS data from the authentication module
calculate exact GPS coordinates from said raw GPS data, and
send the exact GPS coordinates to the authentication module.

5. A system for authenticating a document associated with a geographical location, the system comprising:
a plurality of GPS satellites,
an electronic certification unit, and
at least one portable electronic device as recited in claim 4.

6. A computer program product for authenticating a document associated with a geographical location, the program product containing instructions which, when being executed on a portable electronic device, carry out the method as recited in claim 1.
